(19) United States
(12) Patent Application Publication
(10) Pub. No.: US 2016/0095042 A1
(43) Pub. Date: Mar. 31, 2016

(54) SYSTEM AND METHOD OF NETWORK BASED IP FLOW MOBILITY WITHOUT UE BASED SIGNALING

(71) Applicant: SANJAY WADHWA, CUPERTINO, CA (US)

(72) Inventor: SANJAY WADHWA, CUPERTINO, CA (US)

(73) Assignee: ALCATEL-LUCENT USA INC., MURRAY HILL, NJ (US)

(21) Appl. No.: 14/501,227

(22) Filed: Sep. 30, 2014

(51) Int. Cl. H04W 40/02

(52) U.S. Cl. CPC H04W 40/02; H04W 80/04

(57) ABSTRACT

Methods apparatus and systems providing a mechanism for policy-based steering of user flows/applications via paths traversing different access networks between multi-homing user equipment (UE) and a gateway device in a manner avoiding UE signaling, wherein the UE address is the same for each path, and wherein the same flow/application paths are selected by both the UE and the gateway device in accordance with-based criteria.

### TECHNICAL FIELD

The invention relates generally to managing network resources and, more specifically but not exclusively, to a network based policy for selection of radio access technology on an IP flow basis for traffic between user equipment and network equipment.

### BACKGROUND

User equipment (UE) such as smart phones, tablet computers and the like is typically capable of communicating via multiple access technologies, such as various Wi-Fi networks (e.g., 802.11x networks and the like) as well as various mobile network technologies (e.g., 3GPP, LTE and the like). Within the context of mobile services provided to multi-homed UE, it is preferable to route traffic flows/applications to such UE via the appropriate access technology. Current techniques to achieve this involve dual-stack Mobile-IPv6 (DS-MIPv6), which involves signaling from the UE to the network to establish the appropriate access technology for particular traffic flows/applications. Unfortunately, this is a relatively cumbersome and resource-consuming procedure given the very large number of UEs that may be in use at any time.

### SUMMARY

Various deficiencies of the prior art are addressed by the present invention of method, apparatus and system providing a mechanism for policy-based steering of user flows/applications via paths traversing different access networks between multi-homing user equipment (UE) and a gateway device in a manner avoiding UE signaling, wherein the UE address is the same for each path, and wherein the same flow/application paths are selected by both the UE and the gateway device in accordance with-based criteria. This mechanism avoids the need for UE signaling since both the UE and PGW/GGSN simultaneously select the appropriate access technologies based on the common criteria/selection policy. In this manner, management resources associated with UE signaling are conserved while providing an easily scaled multiple access technology solution.

In various embodiments, the policy-based steering mechanism is based upon one or more of types of traffic flows (e.g., streaming media, telephony, data transfer, secure session etc.), applications (e.g., Netflix, Gmail, WebEx etc.), subscriber entity status (e.g., gold/silver/bronze level subscribers), content provider status (e.g., gold/silver/bronze level content providers), service provider status and the like, wherein the respective policies are configured to be interpreted and implemented in a coordinated manner by UE and service provider equipment, such as for identifying and invoking preferred access technologies.

A method of steering traffic associated with multi-homed user equipment (UE) according to one embodiment comprises receiving, at a gateway device configured to communicate with a multi-homed UE via any of a plurality of paths, policy information including path selection rules; and selecting, at the gateway device and using the path selection rules, one of the plurality of paths for communicating with the multi-homed UE via an IP address common to each of the plurality of paths, each of the plurality of paths being associated with a respective access network; wherein the path selection rules configure the gateway device to select the same one of the plurality of paths as selected by the UE.

### BRIEF DESCRIPTION OF THE DRAWING

The teachings of the present invention can be readily understood by considering the following detailed description in conjunction with the accompanying drawings, in which:

FIG. 1 depicts a high-level block diagram of a system benefiting from various embodiments;

FIG. 2 depicts a flow diagram of a method according to various embodiments; and

FIG. 3 depicts a high-level block diagram of a general purpose computing device suitable for use in various embodiments.

To facilitate understanding, identical reference numerals have been used, where possible, to designate identical elements that are common to the figures.

### DETAILED DESCRIPTION

The invention will be primarily described within the context of a system in which a mechanism for policy-based steering of user flows/applications at user equipment (UE) is multi-homed to mobile network provider equipment (PE) such as a packet gateway device (e.g. GGSN/PGW) to provide thereby coordinated selection of access technologies in a manner avoiding UE/PE signaling. In this manner, traffic flows to and from the UE may be migrated from one gateway device to another, from one access technology path to another (e.g., Wi-Fi/LTE) and so on without additional signaling/interaction with the UE. Such additional UE signaling is avoided by causing both the UE and PE to simultaneously select the same access technologies (i.e., multi-homed paths therethrough) according to policy information including path selection rules.

Various embodiments provide a mechanism for policy-based steering of user flows/applications at both the user equipment (UE) and at the PGW/GGSN. This policy-based steering mechanism may be based upon one or more of types of traffic flows (e.g., streaming media, telephony, data transfer, secure session etc.), applications (e.g., Netflix, Gmail, WebEx etc.), subscriber entity status (e.g., gold/silver/bronze level subscribers), content provider status (e.g., gold/silver/bronze level content providers), service provider status and the like. Generally speaking, the respective policies are configured to be interpreted and implemented in a coordinated manner by both UE and PE to coordinate path selection in a manner avoiding UE/PE signaling. The policy-based steering avoids the need for UE signaling since both the UE and the PGW/GGSN simultaneously select the appropriate access technologies. In this manner, management resources associated with the UE are conserved while providing an easily scaled multiple access technology solution.

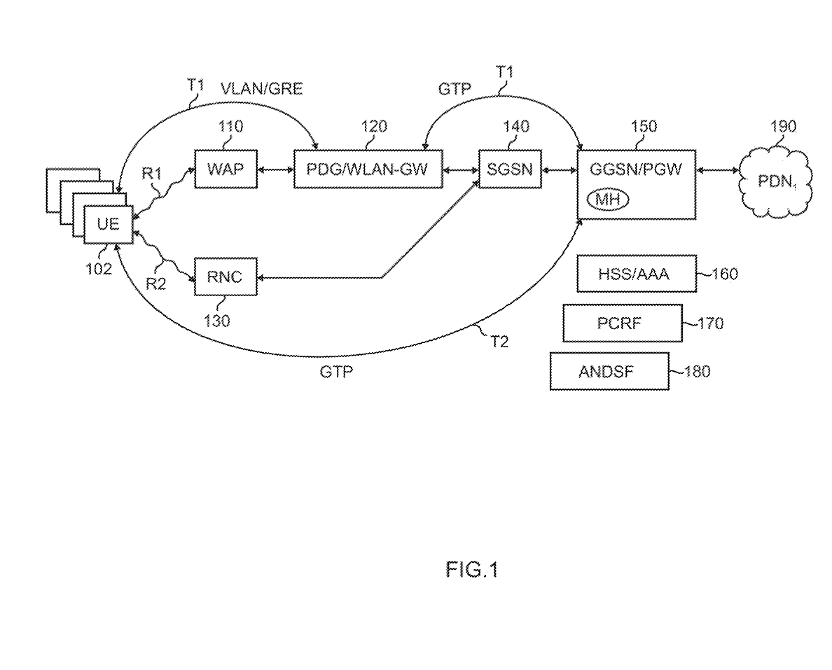

FIG. 1 depicts a high-level block diagram of a system benefiting from various embodiments. Generally speaking, the system 100 of FIG. 1 contemplates user equipment (UE) illustratively capable of accessing a mobile network directly via a Radio Network Controller (RNC) or via a wireless access point (WAP). The mobile network may comprise a 3G/4G mobile network such as a 3GPP network, Universal Mobile Telecommunications System (UMTS) network, long-term evolution (LTE) network and so on. The WAP may be associated with a Wi-Fi, WiMAX or other wireless access network. Various embodiments provide a mechanism whereby UE control/data support is transitioned between Wi-Fi and UMTS in a coordinated manner according to a policy-based steering mechanism.

Specifically, the system 100 of FIG. 1 comprises, illustratively, user equipment (UE) 102, Wireless Access Point (WAP) 110, Packet Data Gateway (PDG)/Wireless LAN gateway (WLAN-GW) 120, radio network controller (RNC) 130, Serving GPRS Support Node (SGSN) 140, Gateway GPRS Support Node (GGSN)/Packet Gateway (PGW) 150, Home Subscriber Server (HSS)/Authentication, Authorization and Accounting (AAA) server 160, Policy and Charging Rules Function (PCRF) 170, Access Network Discovery and Selection Function (ANDSF) 180 and various other network elements (not shown) supporting control plane and/or data plane operations as described herein.

Generally speaking, UEs 102 are multi-homed to a gateway device such as the GGSN/PGW 150 via a first path or tunnel T1 associated with a first access technology (e.g., WiFi) and a second path or tunnel T2 associated with a second access technology (e.g., LTE). In various embodiments, more than two paths or tunnels may be used by at least some of the UEs 102. In various embodiments, different paths or tunnels may traverse the same or similar access technologies in whole or in part.

In the exemplary system 100 of FIG. 1, first path or tunnel T1 is depicted as a WiFi supported L2 connection (e.g. Virtual Local Area Network (VLAN)) or L3 tunnel (e.g. Generic Routing Encapsulation (GRE) tunnel) between UE 102 and WLAN-GW/PGW 120, and a GTP tunnel between WLAN-GW/PGW 120 and GGSN/PGW 150. Similarly, second path or tunnel T2 is depicted as a cellular network supported GTP tunnel between UE 102 and GGSN/PGW 150.

In various embodiments, UEs 102 may be multi-homed to other Gateway devices such as SGSN 140. In various embodiments, such as within the context of other types of mobile networks, UEs 102 may be multi-homed to Service Gateway (SGW), Packet Gateway (PGW) and/or other types of PE relevant to these other types of mobile networks. Various embodiments contemplate that each multi-homed UE path is associated with a respective access network or access technology, such that various criteria may be used to select an appropriate path for use at any given time, which criteria are used by both the UE and the gateway device to contemporaneously select the same access technology or path therethrough supporting communications therebetween.

With respect to the first tunnel T1, UE 102 communicates with a Packet Data Gateway (PDG) or Wireless Local Area Network Gateway (WLAN-GW) 120 via a Wireless Access Point (WAP) 110 to receive mobile services thereby. The mobile services are communicated between the PDG/WLAN-GW 120 and the GGSN/PGW 150 via a tunnel such as a GPRS Tunneling Protocol (GTP) tunnel, depicted as tunnel T1. The GGSN/PGW 150 communicates with a public packet data network (PDN) 190. UE 102 includes a first radio adapted to communicate with WAP 120 via a Wi-Fi-compliant radio signal R1. The communication between the UE 102 and PDG/WLAN-GW 120 may be via a L2 connection (e.g. VLAN) or L3 tunnel (e.g. GRE tunnel). With respect to the second tunnel T2, UE 102 communicates with the SGSN 140 via RNC 132 to receive mobile services thereby. The mobile services are communicated between the RNC 130 and the GGSN/PGW 150 via a tunnel such as a GTP tunnel, depicted as tunnel T2. UE 102 includes a second radio adapted to communicate with RNC 130 via a 3G, 4G/LTE compliant radio signal R2.

Each UE 102 is associated with a respective single or common Internet Protocol (IP) address, which address is used to identify the UE on each path or tunnel supporting multi-homed communications between the UE and PE to which it is multi-homed (i.e., GGSN/PGW 150). Thus, the IP address associated with a particular UE 102 is the same for both the first tunnel T1 and the second tunnel T2. In this manner, data traffic associated with an application session or other communications between the UE 102 and another network element may be routed via either of the first tunnel T1 and second tunnel T2 without reestablishing or modifying the session.

The PCRF 170 provides dynamic management capabilities by which the service provider may manage rules related to UE user or subscriber Quality of Service (QoS) requirements, rules related to charging for services provided to the UE, rules related to mobile network usage, provider equipment management and so on. Of particular interest, various embodiments contemplate that PCRF 170 provides to gateway devices such as GGSN/PGW 150, SGSN 140 and so on policy information including path selection rules which are used by the gateway device to select which of a respective plurality of paths associated with one or more multi-homed UEs will be used to route traffic between the multi-homed UEs and the gateway device. Thus, various embodiments contemplate that PCRF 170 provides policy-based path selection or routing rules to one or more gateway devices for assigning thereby traffic flows to specific paths, bearer channels and the like.

The Access Network Discovery and Selection Function (ANDSF) 180 assists the UE 102 in discovering access networks such as provided by WAP 110 or other entities (not shown), and to provide the UE with rules governing UE connection policies associated with these access networks. Of particular interest, various embodiments contemplate that ANDSF 180 provides to each multi-homed UE policy information including path selection rules which are used by the multi-homed UE to select which of a plurality of respective paths associated with the multi-homed UE will be used to route traffic between the multi-homed UE and the gateway device. Thus, various embodiments contemplate that ANDSF server 180 provides policy-based path selection or routing rules to each UE for assigning thereby traffic flows to specific radio access type (RAT), bearer channel and the like.

Various embodiments contemplate that each UE 102 includes at least two radios; namely, a Wi-Fi compliant radio and a 3G, 4G/LTE or other compliant radio. More radios may be used. Each of these radios is associated with a virtual interface to facilitate communications thereby. That is, UE 102 is configured to provide virtual interfaces logically overlaid upon respective physical interfaces, wherein each of the virtual interfaces of the UE 102 utilizes a common (i.e., the same) IP address. Applications communicate with UE 102 via virtual interfaces using the same IP address, such that communications may be migrated between either of the physical radio interfaces. Thus, a single application context may include the application communicating with the UE 102 via a virtual interface supporting a Wi-Fi radio, a cellular network, or supporting some other communication path.

In operation, UE 102 may be associated with active sessions for each of a plurality of applications, such as voice, streaming video, streaming audio, gaming related traffic, social media updates, email, instant messaging, data transfer and so on. These applications are mobile services may have differing requirements in terms of Quality of Service (QoS) such that the first tunnel T1 or second tunnel T2 may be a preferred tunnel for that application or mobile service. Further, UE 102 may comprise a mobile device that is changing its location, such as between different wireless access points, different mobile network base stations and the like.

Given that the IP address of the UE 102 is of the virtual interfaces associated with the multiple tunnels, the traffic associated with each of the applications or mobile services terminating at UE 102 may be moved between tunnels at any given time. The various embodiments are adapted to configure, via policies, UE 102 and GGSN/PGW 150 such that each of these entities selects the same tunnel or path for traffic communicated therebetween, such as the respective tunnels used for applications or mobile services terminating at UE 102.

Various embodiments provide a mechanism for policy-based steering of user flows/applications at both user equipment (UE) such as a smart phone or other mobile device, and the corresponding gateway device to which the UE is multi-homed, such as a PGW/GGSN. The policy-based steering of the various embodiments avoids the need for UE signaling since both the UE and the PGW/GGSN simultaneously select the appropriate access technologies. In this manner, management resources associated with UE signaling are conserved while providing an easily scaled multiple access technology solution.

For example, various types of: (1) traffic flows (e.g., streaming media, telephony, data transfer, secure session etc.), (2) applications (e.g., Netflix, Gmail, WebEx etc.), (3) entities (e.g., gold/silver/bronze level subscribers, content providers, service providers etc.) and the like are associated with respective policies identifying and invoking preferred access technologies.

Various embodiments contemplate policy-based routing rules for flows between multi-homed UE and gateway devices such as PGW/GGSN, SGSN, SGW and so on.

Various embodiments contemplate a single IP address for each UE, the single IP address used for each of multiple radio interfaces associated with the UE, each of multiple bearers associated with the UE and so on. For example, the same IP address may be used for each of a Wi-Fi radio interface and mobile network radio interface associated with the UE. Similarly, the same IP address may use multiple bearer channels such as those channels having the same IMSI and APN, but different TEIDs.

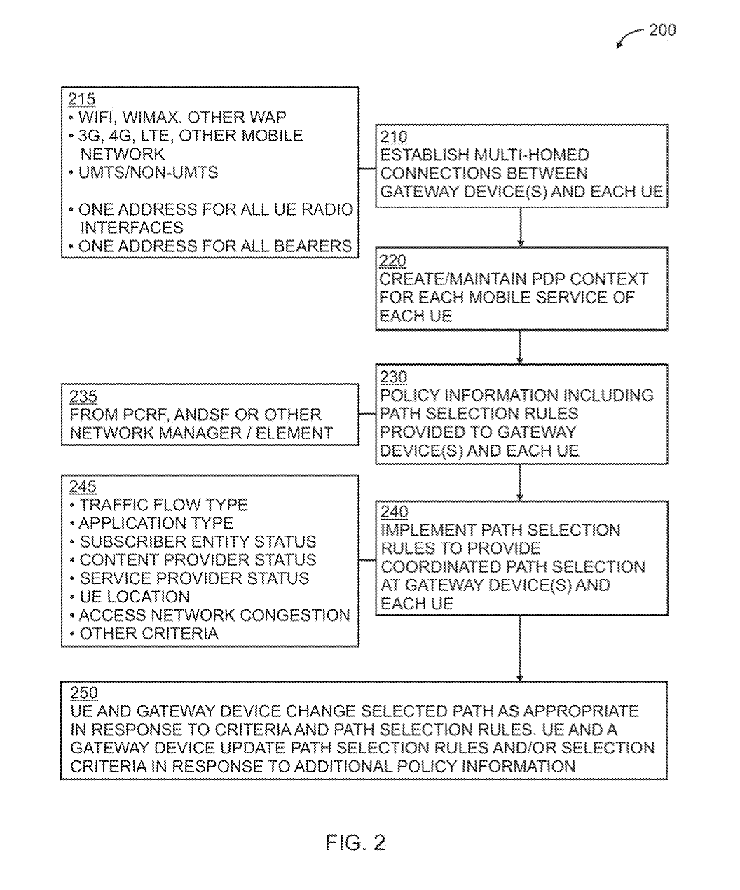

FIG. 2 depicts a flow diagram of a method according to various embodiments.

At step 210, multi-homed connections are established between a gateway device and one or more UEs multi-homed to that gateway device. In various embodiments, multiple gateway devices are contemplated where each Gateway device has associated with it one or more respective multi-homed UEs. Each multi-homed UE communicates with a Gateway device via two or more paths. In various embodiments, each path is associated with a respective access network or access network technology. In various embodiments, each path may be routed to a common access network technology (e.g., different paths through one or more Wi-Fi access points). Referring to box 215, technologies supporting multi-homed paths may comprise Wi-Fi, WiMAX or other Wi-Fi access points (WAPs), 3G, 4G/LTE or other type of mobile network. More generally, technologies supporting multi-homed paths may comprise any UMTS or non-UMTS networks. Further, each multi-homed UE uses one common IP address for each of the multi-homed paths bearing traffic between the UE and the gateway device. Thus, one IP address may be provided for all UE radio interfaces, all bearers and so on.

At step 220, the appropriate PDP context for each mobile service of each UE is created or maintained as necessary.

At step 230, policy information including path selection rules are provided to each gateway device and each UE supported by the gateway device. Referring to box 235, policy information may be provided from the PCRF, ANDSF or other network manager or network element.

At step 240, the path selection rules are implemented at each Gateway device and each UE supported by the gateway device to provide thereby coordinated path selection between the gateway device and the UEs. Referring to box 245, path selection may be adapted per the path selection rules based on one or more criteria, such as based upon one or more of types of traffic flows (e.g., streaming media, telephony, data transfer, secure session etc.), application type (e.g., Netflix, Gmail, WebEx etc.), subscriber entity status (e.g., gold/silver/bronze level subscribers), content provider status (e.g., gold/silver/bronze level content providers), service provider status, UE location, access network congestion and/or other criteria.

At step 250, multi-homed UE and corresponding gateway devices change the selected multi-homed communication paths in a coordinated, substantially simultaneous manner in response to applying, at each of the UE and corresponding gateway device, the same path selection rules to the various criteria as discussed herein. Further, UE and corresponding gateway devices update path selection rules and/or selection criteria in response to additional policy information, such as described above with respect to step 230.

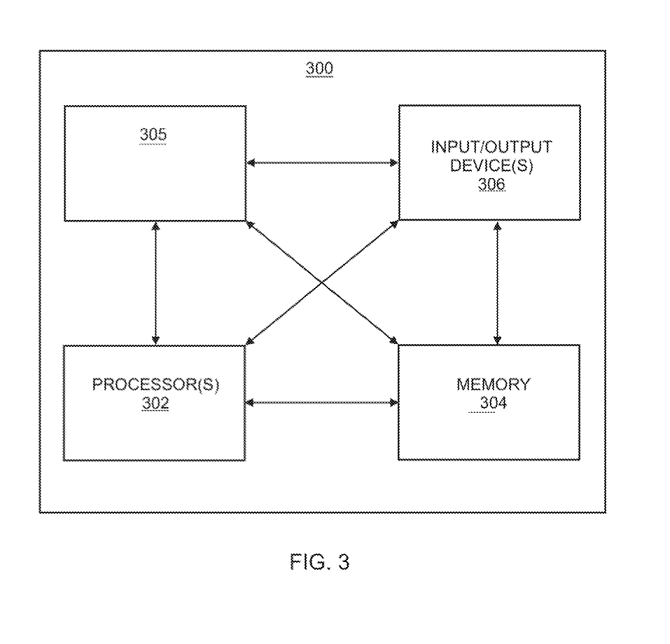

FIG. 3 depicts a high-level block diagram of a computing device, such as a processor in a telecom network element, suitable for use in performing functions described herein such as those associated with the various elements described herein with respect to the figures. The telecom network element may comprise any of the network elements discussed herein, such as the UE 102, WAP 110, PDG/WLAN-GW 120, RNC 130, SGSN 140, GGSN/PGW 150, HSS/AAA 160, PCRF 170, ANDSF 180 and various other network elements or sub-elements (not shown) supporting the control plane and/or data plane operations as described herein.

As depicted in FIG. 3, computing device 300 includes a processor element 303 (e.g., a central processing unit (CPU) and/or other suitable processor(s)), a memory 304 (e.g., random access memory (RAM), read only memory (ROM), and the like), cooperating module/process 305, and various input/output devices 306 (e.g., communications interfaces, user input devices (such as a keyboard, a keypad, a mouse, and the like), a user output device (communications interfaces, user output devices such as a display, a speaker, and the like), an input port, an output port, a receiver, a transmitter, and storage devices (e.g., a persistent solid state drive, a hard disk drive, a compact disk drive, and the like)).

In the case of a routing or switching devices or nodes such described herein, the cooperating module process 305 implement various switching devices, routing devices, interface devices and so on as noted those skilled in the art. Thus, the computing device 300 is implemented within the context of such a routing or switching device (or within the context of one or more modules or sub-elements of such a device), further functions appropriate to that routing or switching device or also contemplated and these further functions are in communication with or otherwise associated with the processor 302, input-output devices 306 and memory 304 of the computing device 300 described herein.

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product comprising a non-transitory computer readable medium storing instructions for causing a processor to implement or invoke methods and/or techniques described herein. Instructions for invoking the inventive methods may be stored in tangible and non-transitory computer readable medium such as fixed or removable media or memory, and/or stored within a memory within a computing device operating according to the instructions.

Various embodiments contemplate an apparatus including a processor and memory, where the processor is configured to perform the various functions described herein, as well communicate with other entities/apparatus including respective processors and memories to exchange control plane and data plane information in accordance of the various embodiments.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method of steering traffic associated with multi-homed user equipment (UE), the method comprising:
receiving, at a gateway device configured to communicate with a multi-homed UE via any of a plurality of paths, policy information including path selection rules; and
selecting, at said gateway device and using said path selection rules, one of said plurality of paths for communicating with said multi-homed UE via an IP address common to each of said plurality of paths, each of said plurality of paths being associated with a respective access network;
wherein said path selection rules configure said gateway device to select the same one of said plurality of paths as selected by said UE.

2. The method of claim 1, further comprising forwarding said policy information from said gateway device toward said multi-homed UE.

3. The method of claim 1, wherein said path selection rules are used by said gateway device and said multi-homed UE for communicating therebetween.

4. The method of claim 1, wherein said path selection rules are used by said gateway device and said multi-homed UE to select a new one of said plurality of paths for communicating there between.

5. The method of claim 1, wherein said gateway device comprises a PGW/GGSN supporting for each UE a single IP address for each of a plurality of UE radio interfaces, each UE radio interface being associated with a respective one of said plurality of paths.

6. The method of claim 5, wherein said gateway device comprises a PGW/GGSN supporting for each UE a single IP address for each of a plurality of bearer channels, each bearer channel being associated with a respective one of said plurality of paths.

7. The method of claim 5, wherein a first UE radio interface supports communications with a wireless access point (WAP), and a second UE radio interface supports communications with a Radio Network Controller (RNC).

8. The method of claim 1, wherein said policy information is provided to said gateway device by a PCRF.

9. The method of claim 1, wherein said policy information is provided to said UE via an ANDSF server.

10. The method of claim 1, further comprising forwarding said policy information from said gateway device toward each multi-homed UE supported by said gateway device, each multi-homed UE associated with a respective IP address common to each of the paths between the UE and the Gateway device.

11. The method of claim 1, wherein the first path includes a L2 connection traversing a Wi-Fi access network and terminating at said UE, and the second path includes a L3 connection traversing a cellular network and terminating at said UE.

12. The method of claim 1, wherein the L2 connection comprises a Virtual Local Area Network (VLAN) and the L3 connection comprises a Generic Routing Encapsulation (GRE) tunnel.

13. The method of claim 1, wherein said method is performed for each of a plurality of multi-homed UEs communicate with said gateway device via respective pluralities of paths.

14. The method of claim 1, wherein at least two of said pluralities of paths available to a UE include common path portions.

15. A method of steering traffic associated with multi-homed UE, the method comprising:
propagating, from a network manager, policy information including path selection rules for configuring a gateway device and each of a plurality of multi-homed UEs serviced by the gateway device;
said path selection rules configuring each UE serviced by the gateway device to select a respective one of a plurality of paths between the UE and the gateway device;
said path selection rules configuring the gateway device to select, for each UE serviced by the gateway device, the same one of the plurality of paths selected by the UE;
each multi-homed UE being associated with a single IP address for communicating via any selected path between the UE and the gateway device, each of the plurality of respective paths being associated with the respective access network.

16. The method of claim 15, wherein said gateway device comprises a PGW/GGSN supporting for each UE a single IP address for each of a plurality of UE radio interfaces, each UE radio interface being associated with a respective one of said plurality of paths.

17. An apparatus including a processor and memory, where the processor is configured to perform of steering traffic associated with multi-homed user equipment (UE), the method comprising:
receiving, at a gateway device configured to communicate with a multi-homed UE via any of a plurality of paths, policy information including path selection rules; and
selecting, at said gateway device and using said path selection rules, one of said plurality of paths for communicating with said multi-homed UE via an IP address common to each of said plurality of paths, each of said plurality of paths being associated with a respective access network;
wherein said path selection rules configure said gateway device to select the same one of said plurality of paths as selected by said UE.

18. A tangible and non-transient computer readable storage medium storing instructions which, when executed by a computer, adapt the operation of the computer to provide a method of steering traffic associated with multi-homed user equipment (UE), the method comprising:
receiving, at a gateway device configured to communicate with a multi-homed UE via any of a plurality of paths, policy information including path selection rules; and
selecting, at said gateway device and using said path selection rules, one of said plurality of paths for communicating with said multi-homed UE via an IP address common to each of said plurality of paths, each of said plurality of paths being associated with a respective access network;
wherein said path selection rules configure said gateway device to select the same one of said plurality of paths as selected by said UE.

19. A computer program product comprising a non-transitory computer readable medium storing instructions for causing a processor to implement a method of steering traffic associated with multi-homed user equipment (UE), the method comprising:
receiving, at a gateway device configured to communicate with a multi-homed UE via any of a plurality of paths, policy information including path selection rules; and
selecting, at said gateway device and using said path selection rules, one of said plurality of paths for communicating with said multi-homed UE via an IP address common to each of said plurality of paths, each of said plurality of paths being associated with a respective access network;
wherein said path selection rules configure said gateway device to select the same one of said plurality of paths as selected by said UE.
